(19) United States
(12) Patent Application Publication
(10) Pub. No.: US 2024/0290357 A1
(43) Pub. Date: Aug. 29, 2024

(54) PROGRAMMATIC GENERATION OF SHORT-FORM VIDEOS TO TRANSPORT AUDIO-VISUAL DATA STORIES

(71) Applicant: SAP SE, Walldorf (DE)

(72) Inventors: Matthias Uflacker, Erding (DE); Michael Wittmann, Grafing (DE); Pascal Keilbach, Vaterstetten (DE); Simon Ximeng Zhai, Garching (DE); Ying Dai, Nanjing (CN); Can Liu, Nanjing (CN); Tianyu Yin, Nanjing (CN); Jianmin Xue, Shanghai-Pudong (CN)

(21) Appl. No.: 18/173,145

(22) Filed: Feb. 23, 2023

(51) Int. Cl. G11B 27/036

(52) U.S. Cl. CPC G11B 27/036; G10L 13/02

(57) ABSTRACT

Methods, systems, and computer-readable storage media for receiving a request including a template identifier and a data payload, retrieving, from a data store, a template based on the template identifier, the template being of a first format and defining content elements and data to be depicted in a video, populating one or more data values of the data payload into the template, providing, based on the template, code in a second format that is different from the first format, generating the video based on the code, and transmitting the video to one or more users.

### BACKGROUND

Enterprises generate significant amounts of data representative of operations. For example, data can be representative of sales, profits, expenditures, taxes, employment statistics, and the like, among numerous other examples. Agents of enterprises (e.g., employees) frequently need to be aware of, interact with, and understand data in execution of tasks. However, the mass of available information requires adaption to new formats and interaction patterns to consume information efficiently ad-hoc, anytime, and anywhere.

Video is a compelling medium for communication. For example, advertisements often use video to engage consumers more effectively than other types of media (e.g., print, radio). Videos often include content that is used to provide information, which enables viewers to make decisions. For example, videos can be used in presentations to effectively engage an audience and inform the audience on particular topics. Further, video content has shown to be more memorable, to better guide the viewer's attention to what is important and change the way professionals communicate in a decidedly positive way. Relatively short, so-called bite-sized video content has seen a recent surge in consumer popularity on social media platforms. However, the creation of personalized short-form videos poses several challenges with regard to the technical requirements that enable enterprises to generate and distribute compelling audio-visual data stories in a secure, efficient, and scalable way.

### SUMMARY

In view of the above context, implementations of the present disclosure provide a video generation platform for personalized data stories. More particularly, implementations of the present disclosure are directed to a video generation platform that automatically generates videos based on story templates, story data, and story metadata.

In some implementations, actions include receiving a request including a template identifier and a data payload, retrieving, from a data store, a template based on the template identifier, the template being of a first format and defining content elements and data to be depicted in a video, populating one or more data values of the data payload into the template, providing, based on the template, code in a second format that is different from the first format, generating the video based on the code, and transmitting the video to one or more users. Other implementations of this aspect include corresponding systems, apparatus, and computer programs, configured to perform the actions of the methods, encoded on computer storage devices.

These and other implementations can each optionally include one or more of the following features: the first format is Javascript Object Notation (JSON) and the second format is Hypertext Markup Language (HTML); the content elements include two or more of a vertical stack (VStack), a horizontal stack (HStack), an image, text, a spacer, one or more charts, background audio, and text-to-speech (TTS) audio; actions further include transmitting a job request for text-to-speech (TTS), the job request including text, and receiving TTS audio responsive to the job request, the video including the TTS audio in an audio track; generating the video based on the code includes transmitting a job request to a video generation service that executes the code to provide one or more web pages and that captures screenshots of the one or more web pages as frames of the video, and receiving a video file from the video generation service, the video file being executable to provide the video; providing, based on the template, code includes transmitting a job request to a conversion service that converts the template in the first format to the code in the second format, and receiving the code from the conversion service; and the one or more data values are provided from an application that transmits the request.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts a conceptual architecture including a video generation platform in accordance with implementations of the present disclosure.

FIG. 3 depicts an example architecture including a video generation platform in accordance with implementations of the present disclosure.

FIGS. 4A-4E depict example screenshots of an example video in accordance with implementations of the present disclosure.

FIG. 5 an example process that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to a video generation platform. More particularly, implementations of the present disclosure are directed to a video generation platform that automatically generates videos, also referred to herein as stories, based on story templates, story data, and story metadata. The video generation platform provides interfaces for third-party systems to render videos and publish the videos as a story for defined channels and recipients. In some examples, a story template is provided in a first format (e.g., Javascript Object Notation (JSON)) and is converted to a second format (e.g., Hypertext Markup Language (HTML)), which is used to generate a video.

Implementations can include actions of receiving a request including a template identifier and a data payload, retrieving, from a data store, a template based on the template identifier, the template being of a first format and defining content elements and data to be depicted in a video, populating one or more data values of the data payload into the template, providing, based on the template, code in a second format that is different from the first format, generating the video based on the code, and transmitting the video to one or more users.

To provide further context for implementations of the present disclosure, and as introduced above, enterprises generate significant amounts of data representative of operations. For example, data can be representative of sales, profits, expenditures, taxes, employment statistics, and the like, among numerous other examples. Agents of enterprises (e.g., employees) frequently need to interact with data in execution of tasks. However, the mass of available information requires adaption to new formats and interaction patterns to consume information efficiently ad-hoc, anytime, and anywhere.

Video is a compelling medium for communication. For example, advertisements often use video to engage consumers more effectively than other types of media (e.g., print, radio). Videos often include content that is used to provide information, which enables viewers to make decisions. For example, videos can be used in presentations to effectively engage an audience and inform the audience on particular topics. Further, video content has shown to be more memorable, to better guide the viewer's attention to what is important and change the way professionals communicate in a decidedly positive way. Relatively short, so-called bite-sized video content has seen a recent surge in consumer popularity on social media platforms. However, the creation of personalized short-form videos poses several challenges with regard to the technical requirements that enable enterprises to generate and distribute compelling audio-visual data stories in a secure, efficient, and scalable way.

In an example use case, and without limitation, videos can be used to convey information regarding operations of an enterprise (e.g., sales figures, revenue figures), which information enables users to make decisions on enterprise operations. For example, videos can include embedded visualizations (e.g., in the form of charts, graphs, and the like) that graphically depict information (content) relevant to an audience. In many cases, the information is dynamic, changing over time (e.g., hourly, daily, weekly, quarterly, yearly). For example, an example video can include visualizations based on the revenue of an enterprise, which revenue changes daily.

In view of the above context, implementations of the present disclosure provide a video generation platform. More particularly, implementations of the present disclosure are directed to a video generation platform that lets other applications generate videos dynamically and ad-hoc based on a story template, story data, and story metadata. In some examples, the story template, also referred to as a template, is provided as a structured representation of an audio-visual data story. As used herein, a video, also referred to as a story, can be described as a composition of scenes, visual elements, and style instructions to convey information to viewers. In some examples, the story data is data that is dynamically included into a story as text, charts, graphics, speech, and the like. In some examples, the story metadata includes information to define recipients, channels, and other data required for publishing a story. The video generation platform automatically renders videos based on a story template, story data, and story metadata provided and publishes the videos as a story for defined channels and recipients.

As also described in further detail herein, the video generation platform of the present disclosure provides a story designer, a template repository, and an application (e.g., a mobile application). In some examples, the story designer is provided as a web-based visual design tool that enables the creation and modification of story templates. In some examples, the template repository is used to store and provide pre-defined story templates and styles that can be used as a starting point for the creation of new story templates. In some examples, the application enables individuals in an organization to subscribe to channels and access, comment, and share the latest video stories published for them.

Implementations of the present disclosure are described in further detail with reference to an example use case that includes videos that convey information representative of enterprise operations. It is contemplated, however, that implementations of the present disclosure can be realized in any appropriate use case.

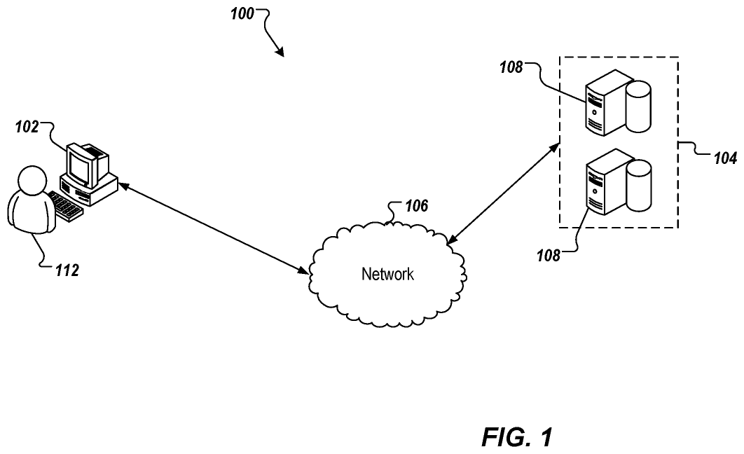

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In some implementations, and as described in further detail herein, story data that is to be conveyed within a video can be provided based on data stored within one or more data sources. In some examples, the data source(s) can be hosted by the server system 104. Example data sources can include, without limitation, a data file (e.g., a comma-separated values (CSV) file) and a database (e.g., an in-memory database). In some examples, data is stored in a data object, which can be provided as a data cube (e.g., an online analytical processing (OLAP) data cube). In some examples, a data cube is provided as an array of data categorized into one or more dimensions. For example, a data cube can be a representation of a multi-dimensional spreadsheet (e.g., a multi-dimensional dataset including a plurality of data tables). In some examples, a data cube includes a plurality of cells, where cells are populated with respective values (e.g., number, text). In some examples, each value represents some measure (e.g., sales, revenue, profits, expenses, budget, forecast).

In some implementations, a data cube can enable manipulation and/or analysis of data stored in the data cube from multiple perspectives (e.g., by dimensions, measures, and/or elements of the data cube). In some examples, a dimension of a data cube defines a category of stored data. Example dimensions can include, without limitation, time, location, product. In some examples, each dimension can have one or more sub-dimensions. For example, the time dimension can include sub-dimensions of year, each sub-dimension of year can include sub-dimensions of quarter, each sub-dimension of quarter can include sub-dimensions of month, each sub-dimension of month can include sub-dimensions of week, and so on. As another example, the product dimension can include sub-dimensions of category, and each sub-dimension of category can include sub-dimensions of line. As another example, the location dimension can include sub-dimensions of country, each sub-dimension of country can include sub-dimensions of region (e.g., north, east, west, south, mid-west), each sub-dimension of region can include sub-dimensions of sub-region (e.g., state, province), and each sub-dimension of sub-region can include sub-dimensions of city. In some examples, a data cube can include three-dimensions. In some examples, a data cube having more than three-dimensions is referred to as a hypercube.

As noted above, data stored in the data object includes one or more measures. In some examples, each measure is a fact (e.g., a numerical fact, a textual fact). In some examples, each measure can be categorized into one or more dimensions. Example measures can include specific product sales data (e.g., quantity sold, revenue, and/or profit margin), categorized by dimension. In short, measures can include any appropriate data that may be manipulated according to logic to assist or support the enterprise.

In accordance with implementations of the present disclosure, and as noted above, the server system 104 can host a video generation platform that automatically generates videos based on a story template, story data, and story metadata. In some examples, videos generated in accordance with implementations of the present disclosure can convey content that changes over time. In some examples, the video is displayed to the user 112 within the client device 102. For example, the video can be displayed within an application executed by the client device 102.

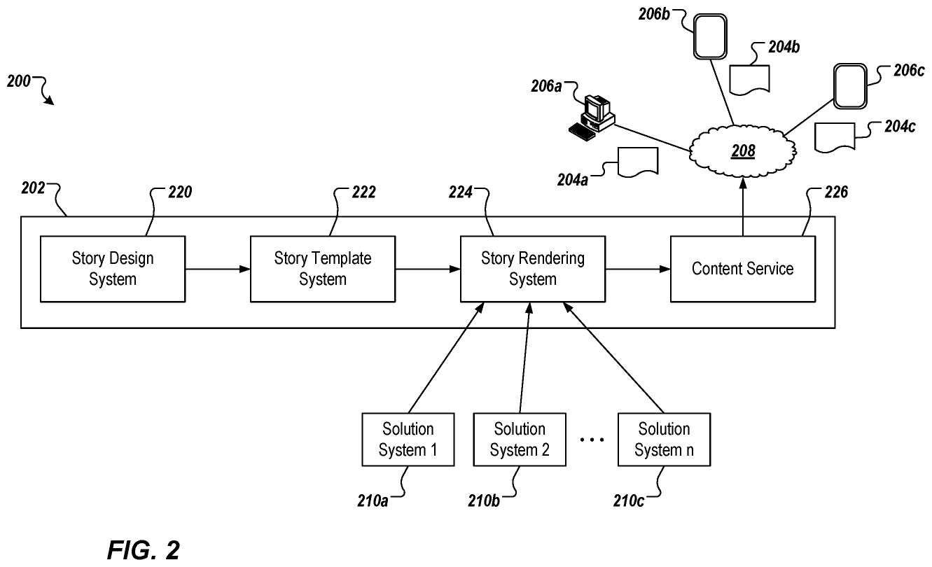

FIG. 2 depicts a conceptual architecture 200 including a video generation platform 202 in accordance with implementations of the present disclosure. In some examples, the video generation platform is provided as a cloud-based platform that can be provisioned in any appropriate cloud runtime. An example cloud runtime includes, without limitation, the SAP Kyma runtime (SKR), which is provided by SAP AG of Walldorf, Germany, and can be described as a fully managed Kubernetes-based runtime. Another example cloud runtime includes Cloud Foundry.

In the example of FIG. 2, the video generation platform 202 automatically generates videos 204a, 204b, 204c that are provided to computing devices 206a, 206b, 206c over a network 208 (e.g., the Internet). As described in further detail herein, the video generation platform 202 can retrieve data from one or more systems 210a, 210b, 210c, and at least a portion of the data can be used as story data in one or more of the videos 204a, 204b, 204c.

In the example of FIG. 2, the video generation platform 202 includes a story design system 220, a story template system 222, a story rendering service 224, and a content service 226. In some examples, the story design system 220 provides a story design application as a web-based visual editing tool for creating, modifying, and managing story templates in a what-you-see-is-what-you-get (WYSIWYG) paradigm. In this manner, designers can create and/or modify story templates in a visual manner without requiring programming skill. In some examples, the story template system 222 enables access to story templates provided by the story design system. In this manner, users can share and re-use story templates. In some examples, and as described in further detail herein, each story template defines a structure and flow of a story as conveyed in a video.

In some examples, the story rendering service 224 can be provided as a cloud-based service for applications to generate the videos 204a, 204b, 204c from respective story templates and publish the videos 204a, 204b, 204c to specified users and/or user groups. As described in further detail herein, the story rendering service 224 can make calls to one or more of the systems 210a, 210b, 210c to retrieve data can be used as story data in one or more of the videos 204a, 204b, 204c. In some examples, data requested from one or more of the systems 210a, 210b, 210c is based on definitions provided in a story template. In some examples, the content service 226 organizes and publishes the videos 204a, 204b, 204c in one or more channels. For example, users can subscribe to channels to receive personalized stories (videos) about a specific topic and/or domain.

In some implementations, each video (story) is based on a declarative JSON schema that enables videos to be dynamically generated based on a story definition. In some examples, a video can be generated as a one-off video based on the story definition. In some examples, the story definition can be provided within a respective story template, such that multiple videos can be generated by reusing the story template. In some examples, the story template (e.g., provided in JSON) serves as a language agnostic abstraction layer. As described in further detail herein, a story can include multiple scenes, each scene representing a sub-chapter of the story. In this manner, when rendered as a video, users can jump back-forth between different parts of the story.

In some implementations, a story template includes metadata section, a content section, and a data section. In some examples, the metadata section includes title metadata, description metadata, channel metadata, allowed user metadata, tags metadata, and data source metadata. The title metadata and the description metadata respectively provide a title and description for the story represented within the story template. The channel metadata indicates one or more channels that videos generated using the story template will be published to. The allowed users metadata identifies one or more users and/or user groups that are able to access the video. The tags metadata enables topics to be added as tags that enable the video to be surfaced in search results (e.g., a search query includes a tag that is included in the story template). The data source metadata indicates one or more data sources (e.g., applications, systems) that provide data to populate for presentation in videos generated using the story templated. In some examples, and as described in further detail herein, the content section contains everything that defines the structure, layout, style, and elements of the story within the story template. In some examples, the data section specifies data that is to be populated in variables of the content section for rendering of the videos.

An example story template is provided in Listing 1:

Listing 1: Example Story Template

```
{
  ### VIDEO DATA STORY METADATA ###
  “title”: “Hello World”,
  “description”: “This is an example”,
```

| | |
|---|---|
| “channel”: “hello-world”, | ### CONTENT CHANNEL |
| “allowed_users”: [ | ### TARGETED USERS |

```
    “example@example.com”
  ],
  “tags”: [
    “example”,
    “helloworld”
```

| | |
|---|---|
| “info_url”: | ### LINK TO THE |
| “https://www.example.org”, | |

```
DATASOURCE/APPLICATION
  ### VIDEO DATA STORY TEMPLATE ###
  “content”: {
    “scenes”: [
      {
        “content”: {
```

| | |
|---|---|
| “type”: “VStack”, | ### VISUAL BUILDING |
| | BLOCK |
| “style”: { | ### STYLING |

```
            “background-color”: “$colorAlt”
          },
          “content”: [
            {
```

| | |
|---|---|
| “type”: “Text”, | ### VISUAL BUILDING |

BLOCK

| | |
|---|---|
| “content”: “{{value}}”, | ### VALUE TO BE |
| | REPLACED |

BY DATA

| | |
|---|---|
| “animations”: [ | ### ANIMATIONS TO BE |

```
APPLIED TO THE ELEMENT
                {
                  “type”: “FlyLeft”,
                  “duration”: 3,
                  “delay”: 1
                }
              ]
            }
          ]
        }
      }
    ]
  },
  ### VIDEO DATA STORY DATA ###
  “data”: {
    “value”: “Video Data Stories”
  }
}
```

In the example of Listing 1, the content section includes a variable (value) that is to be replaced by data (“Video Data Stories”) defined in the data section.

In further detail, and as noted above, the content section defines the structure, the layout, the styling, and the like, of a story. Each story can be composed of standardized elements. In some examples, stories can have a default resolution (e.g., 720×1280 px) and/or frame rate (e.g., 24 fps). In some examples, a designer can define settings through a setting attribute in a story template. Listing 2 provides an example:

Listing 2: Example Settings

```
{
  “content”: {
    “settings”: {
      “width”: 500,
      “height”: 500,
      “fps”: 24
    },
    “scenes”: [
      {
        “content”: {
            “type”: “Text”,
            “content”: “Hello, World!”
          }
      }
    ]
  }
}
```

In some examples, a scenes attribute enables the story to be divided into sub-chapters that users can navigate between when viewing the rendered video. Each scene layout can be built by defining elements within the content section. Example types of scene elements can include, without limitation, vertical stack (VStack), horizontal stack (HStack), image, text, spacer, background audio, and text-to-speech (TTS). Listing 3 provides example scenes:

Listing 3: Example Scenes

```
{
  // ...
  “scenes”: [
    }
      “duration”: 3.5,
      “content”: [
        {
          “type”: “Text”,
          “content”: “Hello”
        }
      ]
    },
    {
      “duration”: 3.5,
      “content”: [
        {
          “type”: “Text”,
          “content”: “World”
        }
      ]
    }
  ]
}
```

where a duration attribute indicates a duration (e.g., in seconds) that particular scene element within a scene will be displayed, type indicates the type of the scene element that is to be displayed, and content is the data of that type of scene element that is to be displayed. For example, Listing 3 provides that the text “Hello” is displayed for 3.5 seconds as a first scene (first sub-chapter) and the text “World” is displayed for 3.5 seconds as a second scene (second sub-chapter).

In some examples, stacks enable grouping of elements in a container. For example, multiple elements can be wrapped in a flexible box (flexbox) when using cascading style sheets (CSS). A stack can contain another stack or any other layout element. In some examples, a VStack aligns all child elements vertically in a column, and alignment and spacing can be controlled by setting style attributes of justify-content, align-items, and align-content. Listing 4 provides an example:

Listing 4: Example VStack

```
{
  “content”: {
    “scenes”: [
      {
        “content”: [
          {
            “type”: “VStack”,
            “content”: [
              {
                “type”: “Text”,
                “content”: “This”
              },
              {
                “type”: “Text”,
                “content”: “is a”
              },
              {
                “type”: “Text”,
                “content”: “VStack”
              }
            ]
          }
        ]
      }
    ]
}
```

In some examples, a HStack aligns all child elements horizontally in a row, and alignment and spacing can be controlled by setting style attributes of justify-content, align-items, and align-content. Listing 5 provides an example:

Listing 5: Example HStack

```
{
  “content”: {
  “scenes”: [
      {
        “content”: [
          {
            “type”: “HStack”,
            “content”: [
              {
                “type”: “Text”,
                “content”: “This”
              },
              {
                “type”: “Text”,
                “content”: “is a”
              },
              {
                “type”: “Text”,
                “content”: “HStack”
              }
            ]
          }
        ]
      }
    ]
  }
}
```

In some examples, an image can be included by providing a uniform resource locator (URL) to the image or embedding the image directly encoded as base64 data. Listing 6 provides an example:

Listing 6: Example Image Additions

```
{
  “content”: {
    “scenes”: [
      {
        “content”: {
          “type”: “Image”,
          “src”: “https://my-image.url.com/my-image.jpg”,
          “style”: {“object-fit”: “contain”}
        }
      },
      {
        “content”: {
          “type”: “Image”,
          “src”:
“data:image/png;base64,iVBORw0KGgoAAAANSUhEUgAAABgAAAAYCAYAAAD
gdz34AAAABHNCSVQICAgIfAhkiAAAAAlwSFlzAAAApgAAAKYB3X3/
          “style”: {“object-fit”: “contain”}
        }
      }
    ]
  }
}
```

In some examples, text can be included through the text element type, as depicted by way of example in Listings 1-5. In some examples, TTS can be provided for text that is included in the story. For example, a TTS attribute can indicate text, for which TTS audio is to be provided (e.g., from a TTS service) and the TTS audio is embedded as a voice-over in a scene of the video. In some examples, if the duration of a scene is specified shorter than a duration of the TTS audio, the scene duration is automatically extended to the duration of the TTS audio.

In some examples, the spacer element type enables blank spaces to be inserted between elements. Example spacer attributes can include a size (e.g., 150 px, 50%). A dimension (e.g., width, height) can be derived from a parent element (e.g., VStack, HStack). Listing 7 provides an example:

Listing 7: Example Spacer

```
{
  “content”: {
    “scenes”: [
      {
        “content”: {
          “type”: “VStack”,
          “content”: [
            {
              “type”: “Text”,
              “content”: “Hello”
            },
            {
              “type”: “Spacer”,
              “size”: “150px”
            },
            {
              “type”: “Text”,
              “content”: “Spacer!”
            }
          ]
        }
      }
    ]
  }
}
```

In some examples, background audio can be included in a story by indicating a URL for the background audio. Listing 8 provides an example:

Listing 8: Example Background Audio

```
{
  “content”:{
    “bg_audio”: [
    {
      “src”: “ https://my-audio.url.com/my-audio.mp3”,
      “begin”:0.0,
      “duration”: 3.0,
      “volume”:0.5
    },
    {
      “src”: “ https://my-public-audio-url.com/audio/my-
audio-file.mp3”,
      “begin”:4.0,
      “duration”: 2.0,
      “volume”:0.7
    }
    ],
    “scenes”: [
    //...
    ]
  }
}
```

where a begin attribute indicates a point in time, at which the background audio starts (e.g., default=0), a duration attribute indicates how long (e.g., in seconds) the background audio is played (e.g., default=duration of the story), and a volume attribute indicates a volume of the background audio (e.g., default=0.7).

In some implementations, style definitions can be applied on a global scale across all elements of the story. For example, if a specific font family along the whole story is to be used, it is inefficient to add this style definition to every single element. In view of this, global style definitions can be added at a top level in a story content node. Global style definitions specified in the story content node are overridden by style definitions provided on individual elements. Listing 9 provides an example:

Listing 9: Example Global Style Definition

```
{
  “style”: {
    “font-family”: “Impact”,
    “font-size”: “72pt”,
    “color”: “#ff0000”,
    “background-color”: “#FFFFFF”
  },
  “content”:{
    “scenes”: [
    //...
    ]
  }
}
```

Implementations of the present disclosure also enable animations to be included in stories. In some examples, an animation can be included for elements by adding a list of animations. A timeline of each animation can be controlled by specifying a duration (e.g., the duration of an animation in a scene) and a delay (e.g., time from beginning of scene until animation starts). Example animations can include, without limitation, fade in (fade in element from transparent to 100% opacity), bounce (bounce effect to element), fly up (element flies upward from bottom border), fly down (element flies downward from top border), fly right (element flies in from right border), fly left (element flies in from left border), wobble (wobble effect to element), grow (grow/shrink effect to element), grow×(grow/shrink effect to width of element), grow y (grow/shrink effect to height of element), letter spacing (letter spacing effect to text), and color change (color change effect to text). Listings 10-21 provide respective examples.

Listing 10: Example Fade In

```
{
  “content”: {
    “scenes”: [
      {
        “duration”: 3,
        “content”: {
          “type”: “Text”,
          “content”: “Hello World”,
          “animations”: [
            {
              “type”: “FadeIn”,
            }
          ]
        }
      }
    ]
  }
}
```

In some examples, an opacity attribute can be provided that defines one or more opacity values (e.g., default=[0%, 100%]), the content being displayed with equidistant durations of opacity values.

Listing 11: Example Bounce

```
{
  “content”: {
    “scenes”: [
      {
        “duration”: 3,
        “content”: {
          “type”: “Text”,
          “content”: “Hello World”,
          “animations”: [
            {
              “type”: “Bounce”,
            }
          ]
        }
      }
    ]
  }
}
```

In some examples, a scale attribute can be provided that defines one or more scale values (e.g., default=[0.5, 1.2, 1]) that define a size of an element, the content being displayed with equidistant durations of scale values.

Listing 12: Example Fly Up

```
{
  “content”: {
    “scenes”: [
      {
        “duration”: 3,
        “content”: {
          “type”: “Text”,
          “content”: “Hello World”,
          “animations”: [
            {
              “type”: “FlyUp”,
            }
          ]
        }
      }
    ]
  }
}
```

In some examples, a position attribute can be provided that defines one or more position values (e.g., default=[100%, 0%]) that the element is to follow.

Listing 13: Example Fly Down

```
{
  “content”: {
    “scenes”: [
      {
        “duration”: 3,
        “content”: {
          “type”: “Text”,
          “content”: “Hello World”,
          “animations”: [
            {
              “type”: “FlyDown”,
            }
          ]
        }
      }
    ]
  }
}
```

In some examples, a position attribute can be provided that defines one or more position values (e.g., default=[−100%, 0%]) that the element is to follow.

Listing 14: Example Fly Right

```
{
  “content”: {
    “scenes”: [
      {
        “duration”: 3,
        “content”: {
          “type”: “Text”,
          “content”: “Hello World”,
          “animations”: [
            {
              “type”: “FlyRight”,
            }
          ]
        }
      }
    ]
  }
}
```

In some examples, a position attribute can be provided that defines one or more position values (e.g., default=[−100%, 0%]) that the element is to follow.

Listing 15: Example Fly Left

```
{
  “content”: {
    “scenes”: [
      {
        “duration”: 3,
        “content”: {
          “type”: “Text”,
          “content”: “Hello World”,
          “animations”: [
            {
              “type”: “FlyLeft”,
            }
          ]
        }
      }
    ]
  }
}
```

In some examples, a position attribute can be provided that defines one or more position values (e.g., default=[100%, 0%]) that the element is to follow.

Listing 16: Example Wobble

```
{
  “content”: {
    “scenes”: [
      {
        “duration”: 3,
        “content”: {
          “type”: “Text”,
          “content”: “Hello World”,
          “animations”: [
            {
              “type”: “Wobble”,
            }
          ]
        }
      }
    ]
  }
}
```

In some examples, a skew attribute can be provided that defines one or more skew values (e.g., default=[−1rad, 0.75rad, −0.5rad, 0]) that the element is to be sequentially skewed by to produce a wobble effect.

Listing 17: Example Grow

```
{
  “content”: {
    “scenes”: [
      {
        “duration”: 3,
        “content”: {
          “type”: “Text”,
          “content”: “Hello World”,
          “animations”: [
            {
              “type”: “Grow”,
            }
          ]
        }
      }
    ]
  }
}
```

In some examples, a scale attribute can be provided that defines one or more scale values (e.g., default=[0%, 100%]) that the element is to grow from and to.

Listing 18: Example Grow X

```
}
  “content”: {
    “scenes”: [
      {
        “duration”: 3,
        “content”: {
          “type”: “Text”,
          “content”: “Hello World”,
          “animations”: [
            {
              “type”: “GrowX”,
            }
          ]
        }
      }
    ]
  }
}
```

In some examples, a scale attribute can be provided that defines one or more scale values (e.g., default=[0%, 100%]) that the element is to grow from and to.

Listing 19: Example Grow Y

```
{
  “content”: {
    “scenes”: [
      {
        “duration”: 3,
        “content”: {
          “type”: “Text”,
          “content”: “Hello World”,
          “animations”: [
            {
              “type”: “GrowY”,
            }
          ]
        }
      }
    ]
  }
}
```

In some examples, a scale attribute can be provided that defines one or more scale values (e.g., default=[0%, 100%]) that the element is to grow from and to.

Listing 20: Example Color Change

```
{
  “content”: {
    “scenes”: [
      {
        “duration”: 3,
        “content”: {
          “type”: “Text”,
          “content”: “Hello World”,
          “animations”: [
            {
              “type”: “ColorChange”,
              “color”: [“$white”, “$FF0000”]
            }
          ]
        }
      }
    ]
  }
}
```

In some examples, a color attribute can be provided that defines a list of colors to be applied to the text.

Listing 21: Example Letter Spacing

```
{
  “content”: {
    “scenes”: [
      {
        “duration”: 3,
        “content”: {
          “type”: “Text”,
          “content”: “Hello World”
          “animations”: [
            {
              “type”: “LetterSpacing”,
              “color”: [“10px”, “0px”]
            }
          ]
        }
      }
    ]
  }
}
```

In some examples, a spacing attribute can be provided that defines a list of spacings to be applied to the text.

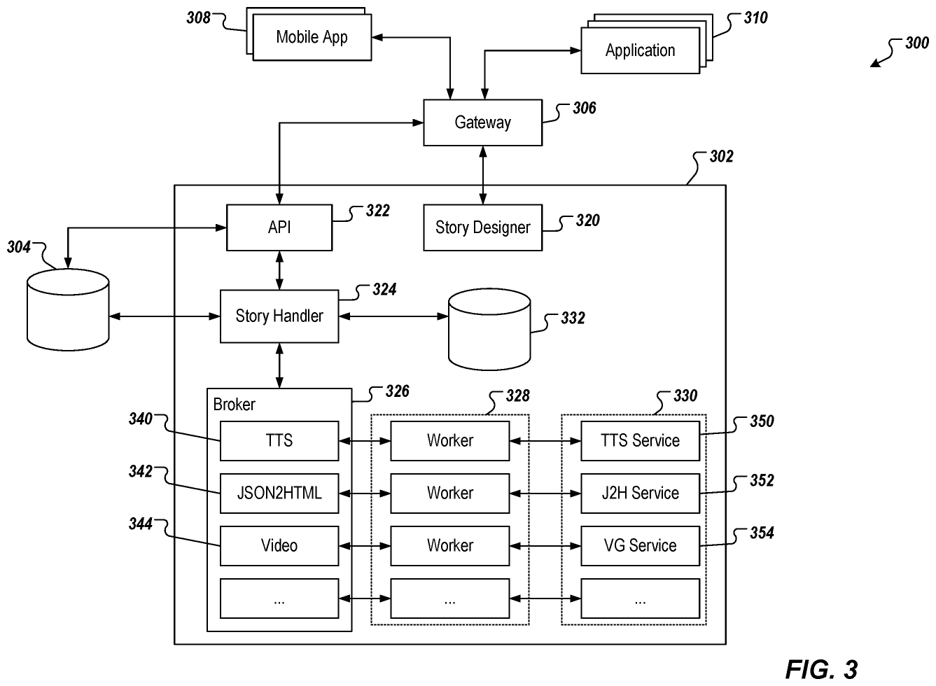

FIG. 3 depicts an example architecture 300 including a video generation platform 302 in accordance with implementations of the present disclosure. In the example of FIG. 3, the video generation platform 302 automatically generates videos that can be stored in a video store 304 and that are published, through a gateway 306, to one or more operating system mobile applications 308. Although mobile applications 308 are referenced herein for purposes of illustration, the video generation platform 302 can publish videos for consumption by any appropriate application. In some examples, and as described in further detail herein, generation and publishing of video can be triggered by one or more applications 310. In the example context, the one or more applications 310 can include software systems used by an enterprise to perform operations of the enterprise. Example software systems can include, without limitation, an enterprise resource planning (ERP) system, a customer relationship management (CRM) system, and a human capital management (HCM) system, among many others.

In the example of FIG. 3, the video generation platform 302 includes a story designer 320, an application programming interface (API) 322, a story handler 324, a broker service 326, a set of workers 328, a set of services 330, and a database. In some examples, the broker 326 includes a set of queues for coordinating execution of jobs to respective services in the set of services 330 through respective workers. For example, a TTS queue 340 communicates with a TTS service 350 through a respective worker, a JSON-to-HTML (JSON2HTML, J2H) 342 communicates with a J2H service 352 through a respective worker, and a video queue 344 communicates with a video generation service 354 through a respective worker. While individual services are depicted in the example of FIG. 3, it is contemplated that one or more of the services can be scaled depending on workload.

In accordance with implementations of the present disclosure, a designer (e.g., a user) can communicate with the story designer 320 through the gateway 306. As introduced above, the story designer 320 can include a web-based visual editing tool for creating, modifying, and managing story templates in a WYSIWYG paradigm. The story template can be stored in the database 332. The story designer 320 can enable the designer to visually create a video by selecting elements (content) to be included in the video and defining attributes of elements (e.g., delay, duration, skew, scale). In response to input of the designer, a story template is automatically generated for the video. For example, for a new video, a basic story template can be provided in JSON and, as the designer selects elements and defines metadata and attributes, the template is populated further. In some examples, the basic template can be automatically populated with JSON code snippets representing each element and respective attributes and/or metadata to provide a story template for the video. In some examples, the designer can provide metadata indicating one or more data sources that are to provide data in the data section to populate variables defined in the content section. Example data sources can include one or more of the applications 310.

As another example, when modifying an existing video, a story template for the video is retrieved from the database 332 and scenes of the video can be displayed to the designer by the story designer 320. In response to input of the designer, the story template can be modified. For example, elements and respective attributes and/or metadata can be added, removed, and/or modified.

In some implementations, each video can be designated for one or more channels, one or more users, and/or one or more user groups. For example, the designer can provide input to the story designer 320 to define channel metadata indicating one or more channels that the video is to be published to, such that users that subscribe to the one or more channels can receive the video. As another example, the designer can provide input to the story designer 320 to define allowed user metadata to indicate one or more users (e.g., by unique identifier, such as email address) that the video is to be accessible to, such that the indicated users can receive the video. As another example, the designer can provide input to the story designer 320 to define allowed user metadata to indicate one or more user groups (e.g., by unique group identifier) that the video is to be accessible to, such that users in the indicated user groups can receive the video.

In some implementations, after creating a story template, the story template can be made available for generating videos. In some examples, a post request for the story template can be sent (e.g., through the API 322). In response to a successful post request, an identifier that uniquely identifies the story template is returned. Listing 22 provides an example post request for the example story template of Listing 1 (with comments removed), and Listing 23 provides an example response:

Listing 22: Example Post Request

```
curl -X ‘POST’
  ‘https://stories-api-prod.c-xyz.kyma.ondemand.com/story/’
  -H ‘accept: application/json’ \
  -H ‘Content-Type: application/json’ \
  -H ‘Authorization: Bearer <YOUR_TOKEN>’\
  -d
  ″title″: ″Hello World″,
  ″description″: ″This is an example″,
  ″channel″: ″hello-world″,
  ″allowed_users″: [
    ″example@example.com″
  ],
  ″tags″: [
    ″example″,
    ″helloworld″
  ],
  ″info_url″: ″https://www.example.org″,
  ″content″: {
    ″scenes″: [
      {
        ″content″: {
          ″type″: ″VStack″,
          ″style″: {
            ″background-color″: ″$colorAlt″
          },
          ″content″: [
            {
              ″type″: ″Text″,
              ″content″: ″{{value}}″,
              ″animations″: [
                {
                  ″type″: ″FlyLeft″,
                  ″duration″: 3,
                  ″delay″: 1
                }
              ]
            }
          ]
        }
      }
    ]
  },
  ″data″: {
    ″value″: ″Video Data Stories″
  }
```

Listing 23: Example Response

{
″_id″: ″634eab497986822fb5533e7c″
}

In accordance with implementations of the present disclosure, after a story template is created and posted, one or more of the applications 310 can trigger generation of a video using the story template. For example, an application 310 can schedule triggers to generate a story based on a respective template (e.g., daily, weekly, monthly, quarterly, annually). As another example, an application 310 can include one or more rules that, if met, trigger generation of a story based on a respective template. In some examples, in response to a trigger, the application 310 generates a request to the video generation platform 302. In some examples, the request includes an identifier (e.g., “634eab497986822fb5533e7c”) that indicates the story template that is to be used and a data payload (e.g., data and metadata to specify eligible users and channels) that provides data values for data that is to be populated in the story template as content within the video that is generated. For example, for a particular story template, data values (e.g., measures from a data cube) that are needed can be defined. The application 310 can retrieve the data values from, for example, a database to include in the data payload.

In some implementations, in response to receiving a request, the story handler manages a series of tasks based on dependencies (e.g., defining an order of task execution). Example tasks can include, without limitation, retrieving the story template, populating the data section of the story template with data provided in the data payload of the request, transmitting one or more jobs to the TTS service 350 (if the story template requests TTS), transmitting a job to the J2H service 352, and transmitting a job to the video generation service 354. An example order of tasks can include transmitting the one or more jobs to the TTS service 350 (if the story template requests TTS), receiving the TTS audio, transmitting the job to the J2H service 352, receiving a HTML file, transmitting the job to the video generation service 354, and receiving the video.

In further detail, the story handler 324 populates the data section of the story template with data values received with the request. For example, story template can include one or more variables representative of one or more measures. The data section of the story template can include a placeholder for a data value for each measure, each placeholder being populated with a respective data value provided in the data payload of the request.

In some examples, if the story template includes TTS elements, a TTS job can be sent for each TTS element to the TTS service 350. In some examples, a TTS element can include constant text (i.e., text that does not change between video generations) within the story template. For example, if the content section defines a TTS text element as ‘Profit this week is down’ the story handler 324 provides a job request to the broker service 326 for processing through the TTS queue 340, which transmits the job request to the TTS service 350 (through a respective worker), the job request including the text ‘Profit this week is down.’ The TTS service 350 returns an audio snippet as audio data that, when executed, audibly plays ‘Profit this week is down.’ In some examples, a TTS element can include variable text (i.e., text that does change between video generations) within the story template. For example, if the content section defines a TTS text element as a variable ‘profit_value,’ the story handler 324 populates the variable with a data value provided in the data payload of the request. For purposes of non-limiting illustration, the data value can be provided as 30%. The story handler 324 provides a job request to the broker service 326 for processing through the TTS queue 340, which transmits the job request to the TTS service 350 (through a respective worker), the job request including the text ‘30%.’ The TTS service 350 returns an audio snippet as audio data that, when executed, audibly plays ‘30%.’ In these examples, the audio data can be played consecutively to provide audio of ‘Profit this week is down’ ‘thirty percent.’

In some implementations, after the data section of the story template has been populated with data values from the data payload and TTS audio, if any, has been generated and received, the story handler 324 provides a job request to the broker service 326 for processing through the JSON2HTML queue 342, which transmits the job request to the J2H service 352 (through a respective worker), the job request including the story template. The J2H service converts the story template into HTML code and returns the HTML code.

In response to receiving the HTML code, the story handler 324 provides a job request to the broker service 326 for processing through the video queue 344, which transmits the job request to the video generation service 354 (through a respective worker), the job request including the HTML code. The video generation service 354 generates a video and returns the video. In some examples, the video generation service 354 generates the video by executing the HTML code in a browser application to provide one or more web pages, which represent content elements. In some examples, the video generation service 354 captures screenshots of the one or more web pages, each screenshot being used as a frame in the video. For example, the video generation service 354 can capture screenshots based on a defined framerate (e.g., 24 fps). The screenshots collectively define the frames of the video (i.e., the visual of the video). In some examples, the video generation service 354 provides one or more audio tracks for playing audio of audio files and/or TTS audio, if any. The frames and audio track(s) are exported to a video file (e.g., .mov, .mp4, .wmv).

In some implementations, the video (video file) is stored in the video store 304. In some examples, one or more users that are determined to be the audience for the video (e.g., based on channel metadata, allowed user metadata) are alerted to the availability of the video. For example, a notification can be transmitted to a mobile application 308 of a user. In some examples, in response to user input (e.g., selecting the notification), the video is retrieved from the video store 304 and transmitted to a device (e.g., smartphone, tablet) of the user to be played. In some examples, instead of transmitting an entire video file to the device, the video can be streamed to the device.

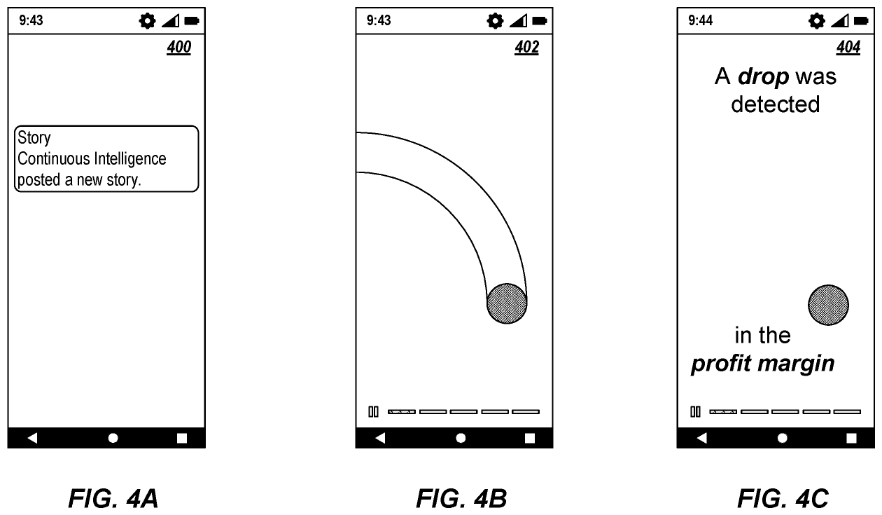

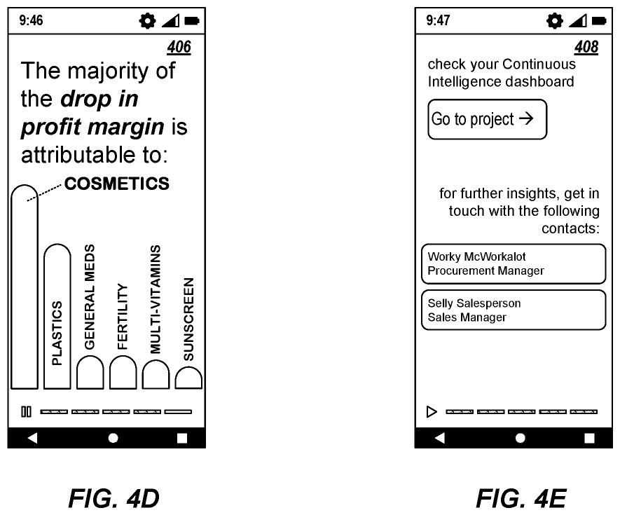

FIGS. 4A-4E depict example screenshots of an example video in accordance with implementations of the present disclosure. While the examples of FIGS. 4A-4E are representative of a mobile device, it is contemplated that videos can be accessed by any appropriate device.

FIG. 4A depicts a notification screen 400 notifying a user that a new story (video) is available for viewing. The user can select an alert displayed in the notification screen 400 to access the video. For example, in response to user selection of the alert, the video is retrieved for display. FIGS. 4B and 4C include scene screenshots 402, 404, respectively, that collectively depict a scene of the video. In the example of FIGS. 4B and 4C, an animation of a ball bouncing downward is depicted and text is displayed that indicates a drop in profit margin. FIG. 4D depicts a screenshot 406 of another scene of the video, in which text and graphics are displayed that indicate contributors to the drop in profit margin. FIG. 4E depicts a screenshot 408 of an end scene of the video and includes interface elements that the user can select to navigate to applications providing other functionality (e.g., open a project within an application, initiate communication (e.g., email, call) with a contact).

In some examples, the example video of FIGS. 4A-4E is automatically generated in response to a request. In some examples, the request can be transmitted based on a schedule and/or one or more rules. For example, the request can be transmitted (e.g., from an application) in response to determining that profit margin has decreased or has decreased by a threshold amount. As another example, the request can be transmitted in response to a schedule (e.g., daily) and determining that the profit margin has decreased. For example, it can be determined that a video is to be generated based on the schedule, but the type of video can be determined based on a rule (e.g., a video discussing profit margin decrease, if the profit margin has decreased; a video discussing profit margin increase, if the profit margin has increased).

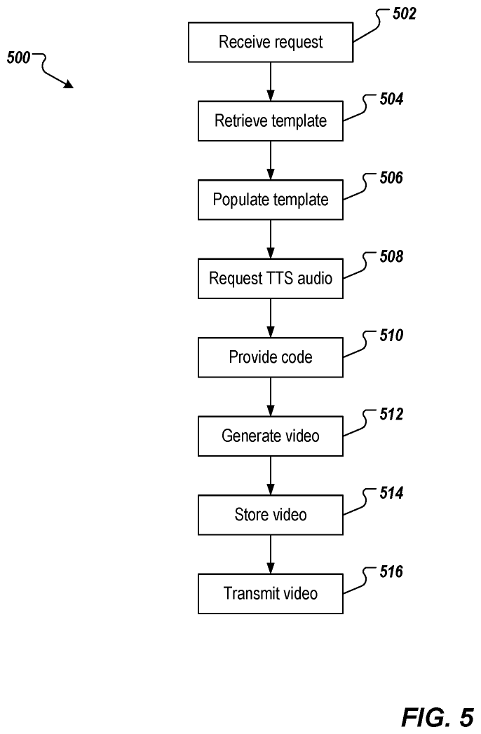

FIG. 5 depicts an example process 500 that can be executed in accordance with implementations of the present disclosure. In some examples, the example process 500 is provided using one or more computer-executable programs executed by one or more computing devices. In some examples, the example process 500 is executed for real-time generation of videos, which can include automatically (e.g., without human intervention) generating a video in response to receiving a request.

A request is received (502). For example, and as described herein, an application 310 of FIG. 3 can transmit a request to the video generation platform 302. In some examples, the request includes an identifier that indicates the story template that is to be used and a data payload that provides data values for data that is to be populated in the story template. A template is retrieved (504). For example, and as described herein, the story handler 324 retrieves the template from the data store 332 based on the identifier provided in the request. The template is populated (506). For example, and as described herein, the story handler 324 populates the data section of the story template with data values received with the request.

If TTS elements are indicated in the template, TTS audio is requested (508). For example, and as described herein, the story handler 324 sends a TTS job for each TTS element to the TTS service 350 and, in response, receives respective TTS audio for the TTS element(s). HTML code is provided from JSON (510). For example, and as described herein, the story handler 324 provides a job request to the broker service 326 for processing through the JSON2HTML queue 342, which transmits the job request to the J2H service 352 (through a respective worker), the job request including the story template. The J2H service converts the story template into HTML code and returns the HTML code.

A video is generated (512). For example, and as described herein, the story handler 324 provides a job request to the broker service 326 for processing through the video queue 344, which transmits the job request to the video generation service 354 (through a respective worker), the job request including the HTML code and TTS audio, if any. The video generation service 354 generates a video and returns the video. The video is stored (514) and the video is transmitted (516). For example, and as described herein, the video (video file) is stored in the video store 304. In some examples, one or more users that are determined to be the audience for the video (e.g., based on channel metadata, allowed user metadata) are alerted to the availability of the video. For example, a notification can be transmitted to a mobile application 308 of a user (e.g., a notification including a link (URL) to the video). In some examples, in response to user input (e.g., selecting the notification, clicking on the link), the video is retrieved from the video store 304 and transmitted to a device (e.g., smartphone, tablet) of the user to be played.

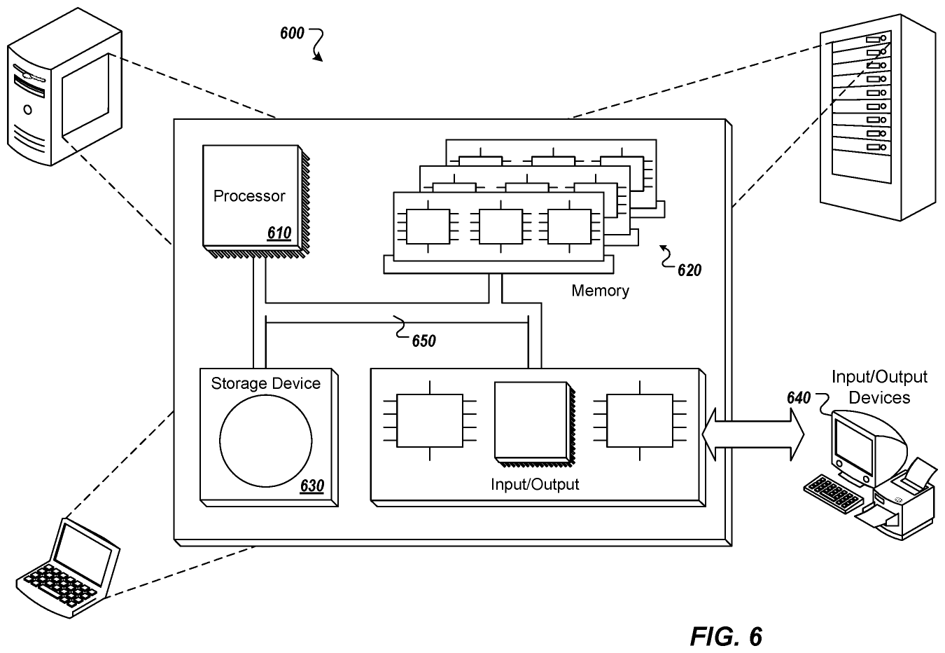

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for programmatic generation of videos, the method being executed by one or more processors and comprising:
receiving a request comprising a template identifier and a data payload;
retrieving, from a data store, a template based on the template identifier, the template being of a first format and defining content elements and data to be depicted in a video;
populating one or more data values of the data payload into the template;
providing, based on the template, code in a second format that is different from the first format;
generating the video based on the code; and
transmitting the video to one or more users.

2. The method of claim 1, wherein the first format is Javascript Object Notation (JSON) and the second format is Hypertext Markup Language (HTML).

3. The method of claim 1, wherein the content elements comprise two or more of a vertical stack (VStack), a horizontal stack (HStack), an image, text, a spacer, one or more charts, background audio, and text-to-speech (TTS) audio.

4. The method of claim 1, further comprising transmitting a job request for text-to-speech (TTS), the job request comprising text, and receiving TTS audio responsive to the job request, the video comprising the TTS audio in an audio track.

5. The method of claim 1, wherein generating the video based on the code comprises:
transmitting a job request to a video generation service that executes the code to provide one or more web pages and that captures screenshots of the one or more web pages as frames of the video; and
receiving a video file from the video generation service, the video file being executable to provide the video.

6. The method of claim 1, wherein providing, based on the template, code comprises:
transmitting a job request to a conversion service that converts the template in the first format to the code in the second format; and
receiving the code from the conversion service.

7. The method of claim 1, wherein the one or more data values are provided from an application that transmits the request.

8. A non-transitory computer-readable storage medium coupled to one or more processors and having instructions stored thereon which, when executed by the one or more processors, cause the one or more processors to perform operations for programmatic generation of videos, the operations comprising:
receiving a request comprising a template identifier and a data payload;
retrieving, from a data store, a template based on the template identifier, the template being of a first format and defining content elements and data to be depicted in a video;
populating one or more data values of the data payload into the template;
providing, based on the template, code in a second format that is different from the first format;
generating the video based on the code; and
transmitting the video to one or more users.

9. The non-transitory computer-readable storage medium of claim 8, wherein the first format is Javascript Object Notation (JSON) and the second format is Hypertext Markup Language (HTML).

10. The non-transitory computer-readable storage medium of claim 8, wherein the content elements comprise two or more of a vertical stack (VStack), a horizontal stack (HStack), an image, text, a spacer, one or more charts, background audio, and text-to-speech (TTS) audio.

11. The non-transitory computer-readable storage medium of claim 8, wherein operations further comprise transmitting a job request for text-to-speech (TTS), the job request comprising text, and receiving TTS audio responsive to the job request, the video comprising the TTS audio in an audio track.

12. The non-transitory computer-readable storage medium of claim 8, wherein generating the video based on the code comprises:
transmitting a job request to a video generation service that executes the code to provide one or more web pages and that captures screenshots of the one or more web pages as frames of the video; and
receiving a video file from the video generation service, the video file being executable to provide the video.

13. The non-transitory computer-readable storage medium of claim 8, wherein providing, based on the template, code comprises:
transmitting a job request to a conversion service that converts the template in the first format to the code in the second format; and
receiving the code from the conversion service.

14. The non-transitory computer-readable storage medium of claim 8, wherein the one or more data values are provided from an application that transmits the request.

15. A system, comprising:
a computing device; and
a computer-readable storage device coupled to the computing device and having instructions stored thereon which, when executed by the computing device, cause the computing device to perform operations for programmatic generation of videos, the operations comprising:
receiving a request comprising a template identifier and a data payload;
retrieving, from a data store, a template based on the template identifier, the template being of a first format and defining content elements and data to be depicted in a video;
populating one or more data values of the data payload into the template;
providing, based on the template, code in a second format that is different from the first format;
generating the video based on the code; and
transmitting the video to one or more users.

16. The system of claim 15, wherein the first format is Javascript Object Notation (JSON) and the second format is Hypertext Markup Language (HTML).

17. The system of claim 15, wherein the content elements comprise two or more of a vertical stack (VStack), a horizontal stack (HStack), an image, text, a spacer, one or more charts, background audio, and text-to-speech (TTS) audio.

18. The system of claim 15, wherein operations further comprise transmitting a job request for text-to-speech (TTS), the job request comprising text, and receiving TTS audio responsive to the job request, the video comprising the TTS audio in an audio track.

19. The system of claim 15, wherein generating the video based on the code comprises:
transmitting a job request to a video generation service that executes the code to provide one or more web pages and that captures screenshots of the one or more web pages as frames of the video; and
receiving a video file from the video generation service, the video file being executable to provide the video.

20. The system of claim 15, wherein providing, based on the template, code comprises:
transmitting a job request to a conversion service that converts the template in the first format to the code in the second format; and
receiving the code from the conversion service.
